(19) United States
(12) Patent Application Publication
(10) Pub. No.: US 2026/0352703 A1
(43) Pub. Date: Nov. 5, 2026

(54) GreenScreen

(71) Applicant: Robert Paul Quinn, George Town (KY)

(72) Inventor: Robert Paul Quinn, George Town (KY)

(21) Appl. No.: 19/198,010

(22) Filed: May 3, 2025

(51) Int. Cl. H04L 9/40

(52) U.S. Cl. CPC H04L 63/145; H04L 63/1408; H04L 63/1416; H04L 63/1425; H04L 63/1433; H04L 63/1441; H04L 63/1458; H04L 63/1483

(57) ABSTRACT

GREENSCREEN™ is an automated threat neutralization system configured to detect and interrupt confirmed AI-generated or synthetic digital threats and visually indicate restoration of a secure operating state. Upon successful threat neutralization, the system applies a green overlay to the user interface, providing immediate confirmation of recovery. Integration hooks allow external security modules to trigger the overlay, while logging and confirmation mechanisms support auditing and controlled resumption of normal operation across devices and platforms.

### TECHNICAL FIELD

The present invention relates to automated systems for neutralizing detected digital threats and restoring user interface safety, and more particularly to systems that provide visual confirmation of threat elimination and controlled restoration of user interaction following AI-generated or synthetic threat mitigation.

### BACKGROUND

Existing cybersecurity and content moderation systems often detect malicious or deceptive digital activity but fail to provide clear, immediate confirmation to users that a threat has been successfully neutralized. Users are frequently left uncertain whether malicious processes, phishing attempts, or AI-generated manipulations have been fully resolved. Additionally, many systems lack integrated visual feedback mechanisms and do not coordinate seamlessly with companion detection modules. There is a need for a system that not only neutralizes threats in real time but also restores user confidence through a clear, intuitive interface transition indicating a verified safe state.

### SUMMARY

GREENSCREEN™ provides an automated threat neutralization overlay system configured to detect, interrupt, and neutralize confirmed digital threats and visually signal restoration of a secure operating state. The system includes a threat detection module, a quarantine or interruption module, and a recovery interface that applies a green visual overlay upon successful threat resolution. Integration hooks allow external detection engines to trigger the overlay, while a compliance interface adapts neutralization behavior to regulatory and environmental requirements. The system ensures rapid, visible confirmation of threat elimination across devices and platforms.

### BRIEF DESCRIPTION OF THE DRAWINGS

FIG. 1 illustrates a system block diagram showing threat detection, quarantine, and neutralization modules within the GREENSCREEN™ system.

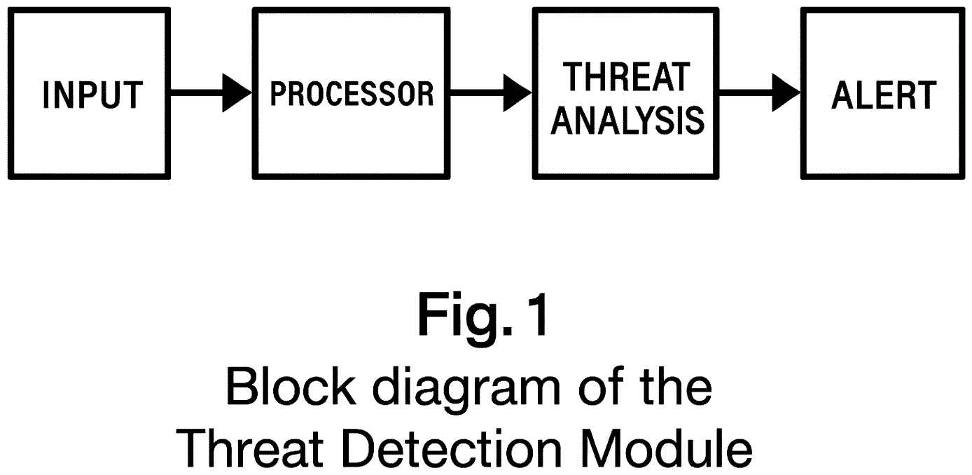

FIG. 2 illustrates a flow diagram of automated application of a green overlay and restoration of user interface functionality following successful threat neutralization.

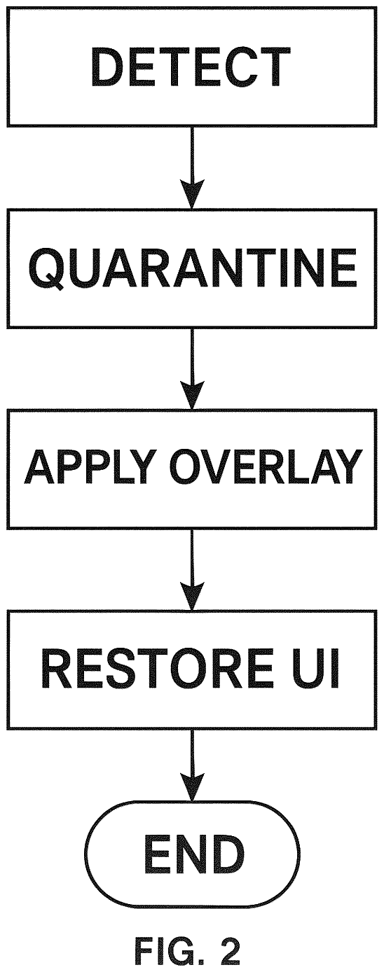

FIG. 3 illustrates a sequence diagram showing integration hooks between external security modules and the GREENSCREEN™ overlay activation process.

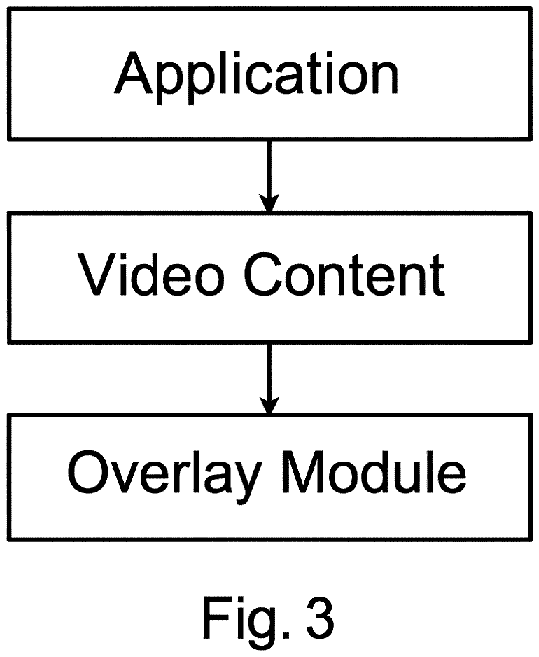

### DETAILED DESCRIPTION

The GREENSCREEN™ system operates within AI-monitored environments to provide automated threat neutralization and visual confirmation of system recovery. A threat detection module evaluates content streams, processes, or communications using signature-based and behavior-based analysis to identify confirmed threats. Upon detection, a neutralization or quarantine module interrupts the threat source by halting execution, blocking communication channels, or disabling malicious processes.

Following successful neutralization, a recovery interface applies a green visual overlay across the user interface, signaling a verified safe state. The overlay may be full-screen or partial and persists until user confirmation or system verification conditions are met. Integration hooks allow companion security systems, including SCROLLSAFE™, SENTRYAWARE™, AI AWARE™, or HUMAN OVERRIDE™, to invoke GREENSCREEN™ following their own remediation events. A compliance interface dynamically adjusts neutralization parameters based on jurisdictional or regulatory requirements.

1. A system for automated threat neutralization in AI-monitored environments, comprising:
a detection engine configured to identify a confirmed AI-originated threat or manipulation attempt;
a neutralization module operable to interrupt the threat source by initiating one or more of communication shutdown, device lock, or source blocking;
a user interface configured to display a transition screen indicating successful threat neutralization using a predefined color, wherein the screen visually turns green upon resolution;
a recovery engine configured to restore normal system operation while maintaining a threat log entry; and
a confirmation prompt enabling a user to verify a restored safe state before resuming use.

2. The system of claim 1, wherein the detection engine identifies phishing, impersonation, deepfake content, or AI-generated manipulation prior to activation of the neutralization module.

3. The system of claim 1, wherein the user interface displays a full-screen green overlay that signals successful threat neutralization and restoration of system security.

4. The system of claim 1, further comprising a Block Source mechanism configured to permanently prevent further contact, data transmission, or content injection from an identified threat origin across linked platforms or user profiles.

5. The system of claim 1, wherein the system is integrated with one or more companion security engines including SENTRYAWARE™, SCROLLSAFE™, AI AWARE™, or HUMAN OVERRIDE™ to enable coordinated threat detection and neutralization across contexts.

6. The system of claim 1, further comprising a threat resolution log configured to capture metadata, timestamp, device state, and user confirmation at the time of GREENSCREEN™ activation for auditing and recovery purposes.

7. The system of claim 1, wherein deactivation of the green transition screen requires biometric authentication or passphrase verification to prevent unauthorized reactivation of a neutralized threat.

8. The system of claim 1, further comprising a privacy-preserving decoy mode that mimics normal device operation while maintaining system lockdown during a monitored or unsafe environment.

9. The system of claim 1, wherein the system is deployable across one or more of mobile devices, desktop systems, browsers, smart televisions, augmented-reality interfaces, or infotainment systems, with behavior dynamically tailored to environment and detected threat severity.
